(19) United States
(12) Patent Application Publication
(10) Pub. No.: US 2005/0197182 A1
(43) Pub. Date: Sep. 8, 2005

(54) Method of playing a game wtih an indicia shuffling feature

(76) Inventor: Gerald Duhamel, Drummondville (CA)

Correspondence Address: LABTRONIX CONCEPT INC.;C/O OGILVY RENAULT, 1981 MC GILL COLLEGE AVENUE, SUITE 1600, MONTREAL, QUEBEC, H3A 2Y3, CA

(21) Appl. No.: 11/070,280

(22) Filed: Mar. 3, 2005

Related U.S. Application Data
(60) Provisional application No. 60/536,855, filed on Mar. 3, 2004.

(51) Int. Cl. A63F 13/00

(52) U.S. Cl. 463/22

(57) ABSTRACT

A method of playing a game of chance comprising providing a plurality of game indicia to form a first outcome and evaluating this outcome according to game rules. At least part of the plurality of game indicia are shuffled to form a second outcome, which is evaluated according to shuffling game rules.

### CROSS-REFERENCE TO RELATED APPLICATIONS

This application claims priority under 35USC§119(e) of U.S. provisional patent application 60/536,855 filed Mar. 3rd, 2004, the specification of which is hereby incorporated by reference.

### TECHNICAL FIELD

The present invention relates to a game using an indicia shuffling feature.

### BACKGROUND OF THE INVENTION

Gambling has evolved a lot during the last few years, and game manufacturers are always searching for new methods to interest and entertain players. Players are always demanding more features and payout schemes.

Improvements in these kinds of games are desired to enhance the player's interest and entertainment.

### SUMMARY OF THE INVENTION

In accordance with an embodiment of the present invention, there is provided a method of playing a game of chance comprising providing a plurality of game indicia to form a first outcome and evaluating this outcome according to game rules. At least part of the plurality of game indicia are shuffled to form a second outcome, which is evaluated according to shuffling game rules

In accordance with another embodiment of the present invention, there is provided a game apparatus comprising: display means to display game indicia forming first and second outcomes; evaluating means to evaluate first outcome according to game rules and second outcomes according to shuffling game rules; and shuffling means to shuffle indicia from the first outcome to form the second outcome.

In accordance to another embodiment of the present invention, there is provided a computer program embodied on a computer readable medium or in processor-readable memory having codes adapted to: provide a plurality of game indicia to form a first outcome; evaluate the first outcome according to game rules; shuffle at least part of the plurality of game indicia to form a second outcome; and evaluate the second outcome according to shuffling game rules.

In accordance to another embodiment of the present invention, there is provided a computer program carried on an electrical or electro-magnetic carrier signal having codes adapted to: provide a plurality of game indicia to form a first outcome; evaluate the first outcome according to game rules; shuffle at least part of the plurality of game indicia to form a second outcome; and evaluate the second outcome according to shuffling game rules.

### BRIEF DESCRIPTION OF THE DRAWINGS

Further features and advantages of the present invention will become apparent from the following detailed description, taken in combination with the appended drawings, in which:

FIG. 1 is a schematic diagram showing a perspective view of a gaming machine suitable for the present invention;

FIG. 2 is a bloc diagram illustrating the components of the gaming machine of FIG. 1;

FIG. 3 is a flowchart illustrating the steps of a simple embodiment of the present invention as played on the gaming machine of FIGS. 1 and 2;

FIGS. 4a and 4b are screen shots representative of two moments in a poker game played according to a simple embodiment of the present invention;

FIG. 5 is a flowchart illustrating the steps of a multi-shuffling embodiment of the present invention;

FIGS. 6a, 6b and 6c are screen shots representative of three moments in a line game played according to a multi-shuffling embodiment of the present invention;

FIGS. 7a, 7b and 7c are screen shots representative of three moments in a line game played according to a partial shuffling embodiment of the present invention; and

FIGS. 8a, 8b and 8c are screen shots representative of three moments in a line game applying shuffling game rules and played according to a partial shuffling embodiment of the present invention.

It will be noted that throughout the appended drawings, like features are identified by like reference numerals.

### DETAILED DESCRIPTION OF THE PREFERRED EMBODIMENT

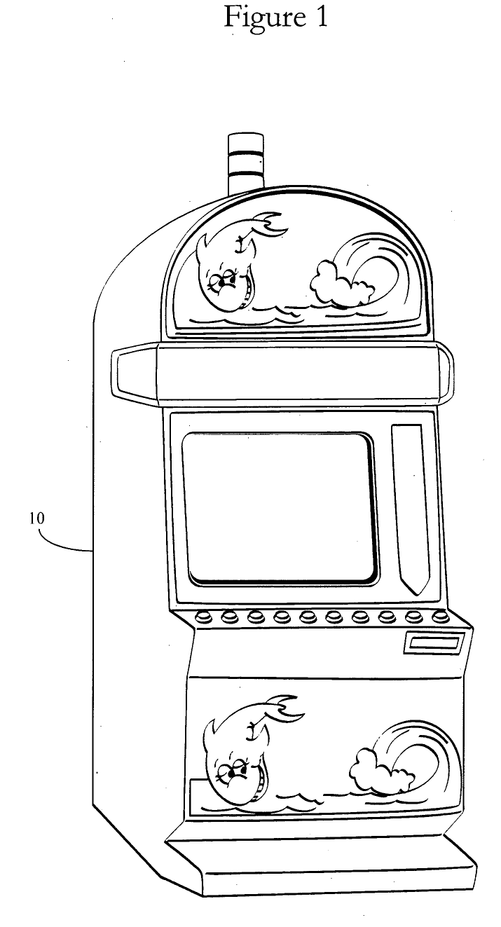

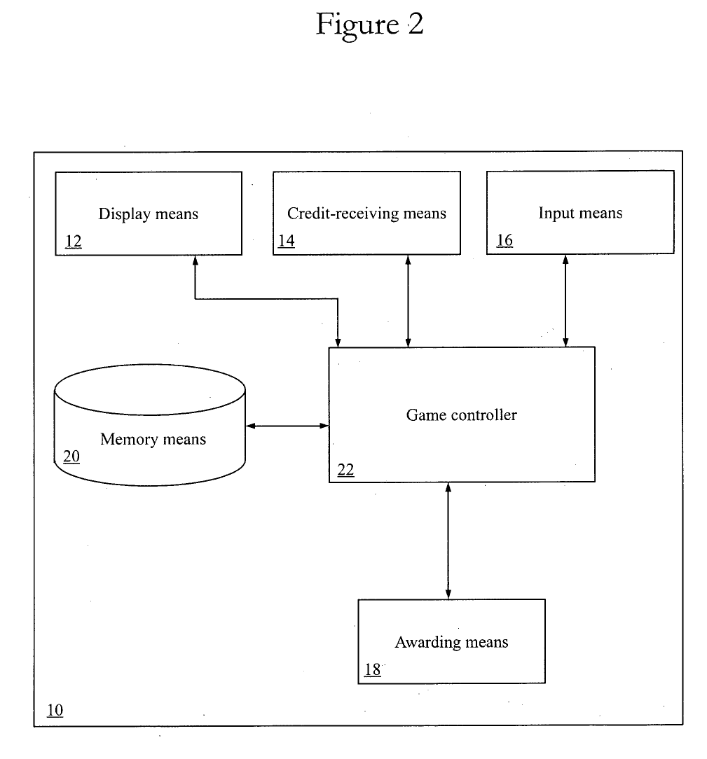

The present invention is preferably carried out on a gaming machine, as illustrated in FIGS. 1 and 2. Said gaming machine 10 comprises display means 12, such as a video screen, an LCD screen or mechanical reels; credit-receiving means 14 such as a card reader, or a coin and/or bill acceptor; input means 16, such as buttons, levers or a touch screen; awarding means 18, such as a ticket printer, a card reader or a hopper; memory means 20; and game controller means 22.

The invention may also be applied in a computer program, or at a remote terminal, the game information (not shown) being distributed via a network, such as linked machines or the Internet, or broadcasted using an electrical or electro-magnetic signal.

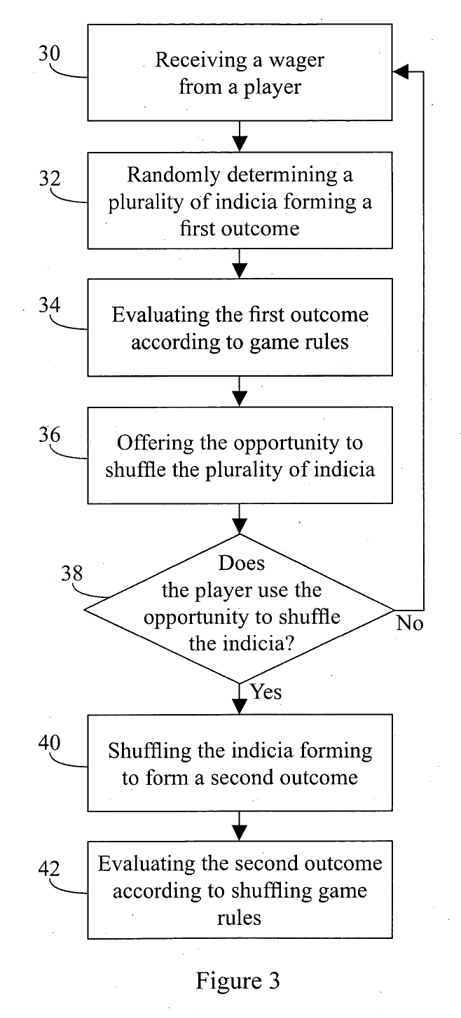

A simple embodiment of the present invention is to allow the player to shuffle all indicia forming a first outcome to form a second outcome. FIG. 3 illustrates the process of a game applying such an embodiment. After a player has placed a wager (step 30), a first outcome is randomly determined (step 32) and evaluated (step 34) according to game rules. The player is offered the opportunity to shuffle the indicia forming this first outcome (step 36). If the player decides to use that opportunity (step 38), the indicia are shuffled (step 40), meaning the indicia are randomly moved, independently from each other, their initial position and the random method used to determine the first outcome. The second outcome formed by the shuffling is evaluated (step 42) according to shuffling game rules and a prize is awarded for any first or second winning outcome.

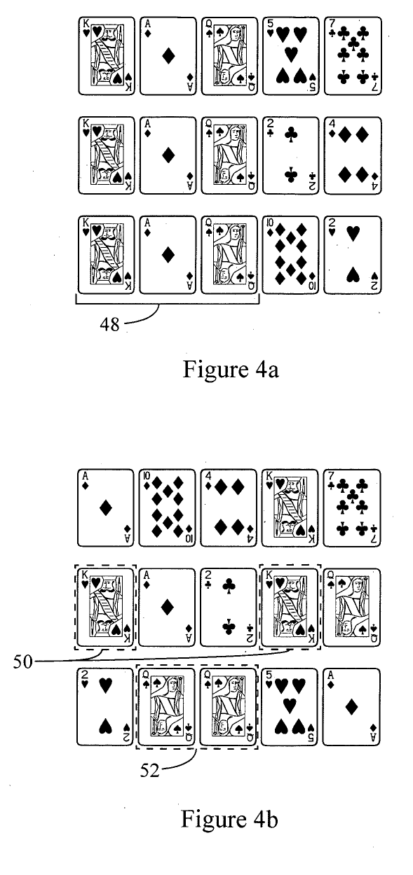

FIGS. 4a and 4b illustrate screen shots of such an embodiment. A multi-hand poker game wherein traditional poker game rules are applied for both the first and second outcomes. FIG. 4a illustrates the player hands after the completion of the poker game: the player has held the King of Heart, the Ace of Diamond and the Queen of Spade 48, his hands have then been completed with new cards. Since no hand results in a winning outcome, the player is offered to reshuffle all his cards (indicia). FIG. 4b illustrates the second outcome, resulting from the reshuffling of the player's cards. The second outcome comprises two (2) winning hands: a pair of Kings 50 and a pair of Queens 52.

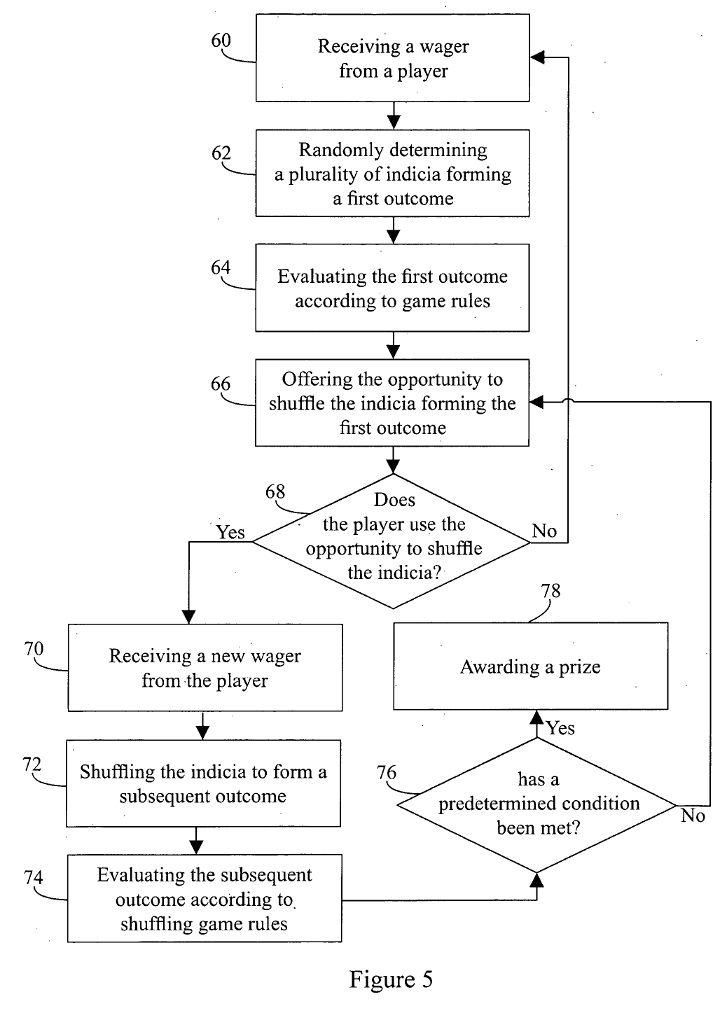

Another embodiment is to offer the player to shuffle the indicia more than once, in exchange of a new wager or not. An embodiment wherein the player has to place a new wager for each shuffling is detailed in FIG. 5. After the player has placed a first wager (step 60), a first outcome is randomly determined (step 62) and evaluated (step 64) according to game rules. The player is offered the opportunity to shuffle the indicia forming said first embodiment (step 66). If the player decides to use this opportunity (step 68), he places a new wager (step 70) and the indicia are shuffled to form a subsequent outcome (step 72), which is then evaluated (step 74) according to shuffling game rules. It is determined whether a predetermined stop condition is met (step 76), said condition determining whether or not the player is offered a new opportunity to shuffle the indicia or not. This condition may be that a predetermined or randomly determined number of shufflings are all used up or that a stop triggering event has occurred in the game, such as a winning or losing outcome. If the condition is not met, a new shuffling opportunity is offered to the player (step 66) while the shuffling feature ends (step 78) if the condition is met, and the player receives no shuffling offer.

In another embodiment, the player is offered to shuffle the indicia only upon occurrence of a predetermined shuffling triggering event. The player may have to use that shuffling permission or “ticket” immediately or be given the opportunity to gather or accumulate them to use them with a more interesting first outcome. In the later case, the player would have the opportunity to shuffle the indicia more than once, until a condition is met (predetermined or randomly determined number of shufflings for example) or until he has used up all his gathered shuffling tickets.

The opportunity to shuffle the indicia may be offered all the time, only upon occurrence of a losing outcome or when the player has gathered at least one shuffling ticket or a combination of these conditions. For example, the player may be offered the opportunity to shuffle the indicia only if the first outcome is a losing outcome and he has gathered at least one shuffling ticket. Another would be to always offer the opportunity to shuffle the indicia one time only, allowing the player to offer a second and more shuffles only if he has gathered at least one shuffling ticket.

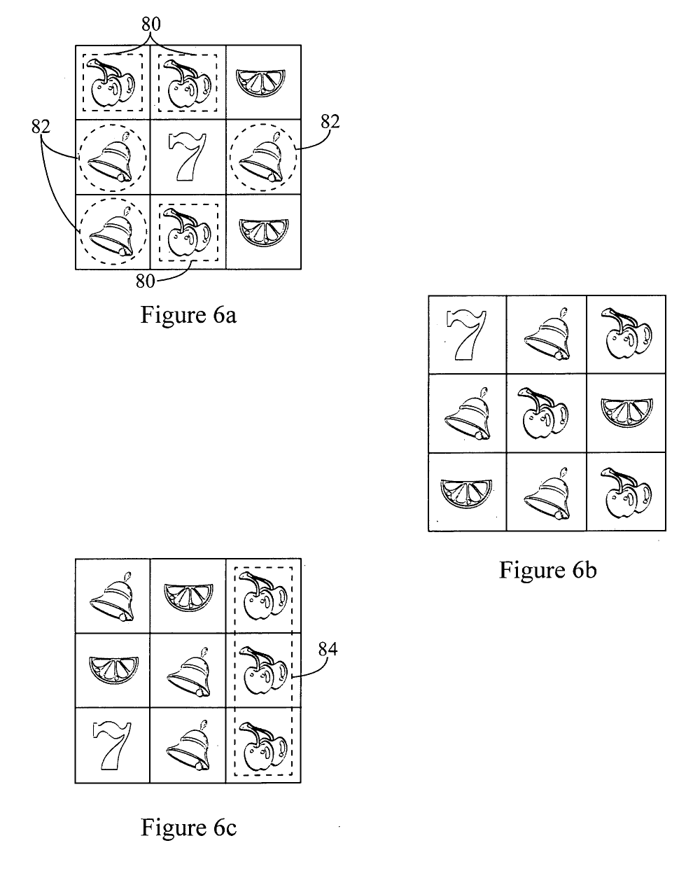

FIGS. 6a, 6b and 6c are screen shots representative of three moments of a line game played according to the embodiment described above, wherein the ticket is used immediately. FIG. 6a illustrates the first outcome. In this example, if the at least two symbols appear three times on the screen, the player is offered the opportunity to shuffle the indicia until a winning outcome occurs. Since the “Cherry” symbol 80 and the “Bell” symbol 82 appear three times each in the first outcome, the symbols are shuffled and a second outcome is formed, as shown on FIG. 6b. The second outcome is evaluated and it is determined that no winning outcome occurred. The symbols are shuffled once again and a subsquent outcome is formed according to FIG. 6c. This time, three “Cherry” symbols are aligned on a payline 84 and thus a winning outcome occurs. The player is awarded a prize based on the payout associated with a line of “Cherry” symbols and the wager placed on the winning payline.

Another embodiment is to allow the shuffling of only part of the indicia but not all. The number and identity of the indicia to shuffle may be: a) predetermined, b) randomly determined, c) determined by the outcome, d) determined by the player, or e) a combination of them. For example, the number of indicia may be determined by the outcome, while their identity would be determined by the player.

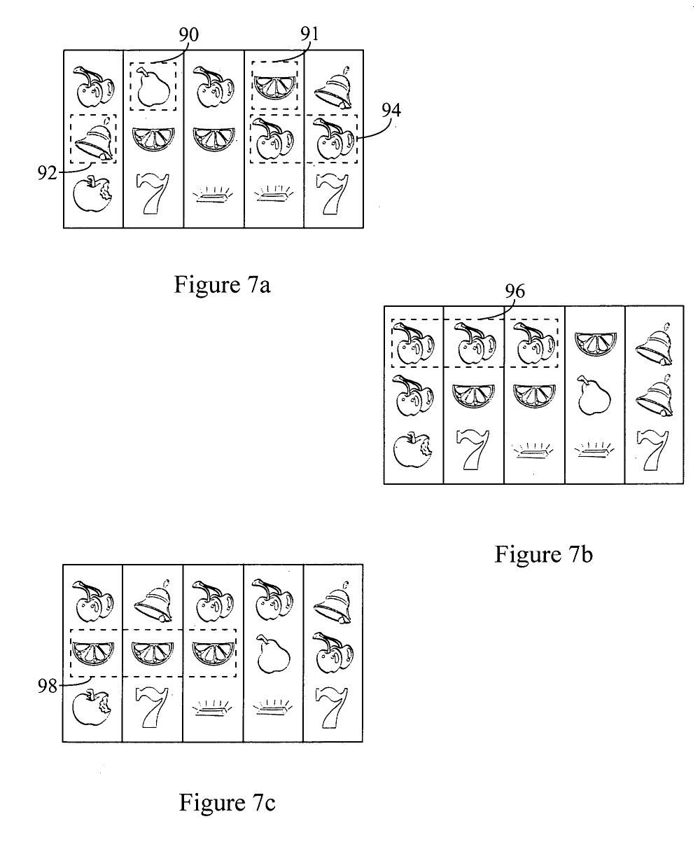

FIGS. 7a, 7b and 7c illustrate a game wherein only some of the indicia are shuffled. In this example, the player may shuffle when he has gathered at least one ticket, and wherein the number and identity of the indicia to shuffle are determined by the player. FIG. 7a illustrates a screen shot of the first outcome. The player determines that his chances of getting at least one winning outcome are good enough, so he uses a ticket to shuffle the symbols he determines would enhance his chances of winning: the “Pear” symbol 90 on the first line so a line of “Cherry” symbols becomes possible, the “Orange” symbol 91 on the first line in the hope of using it for a line of “Orange” symbols, the “Bell” symbol 92 on the second line to open up the line of “Orange” symbols and both “Cherry” symbols 94 on the second line hoping to complete the line of “Cherry” symbols. FIG. 7b illustrates a screen shot of the second outcome, which corresponds to a winning line of “Cherry” symbols 96. Since the player has another ticket, he decides to shuffle the symbols again. FIG. 7c illustrates screen shot of the subsequent winning outcome, including a winning line of “Orange” symbols 98.

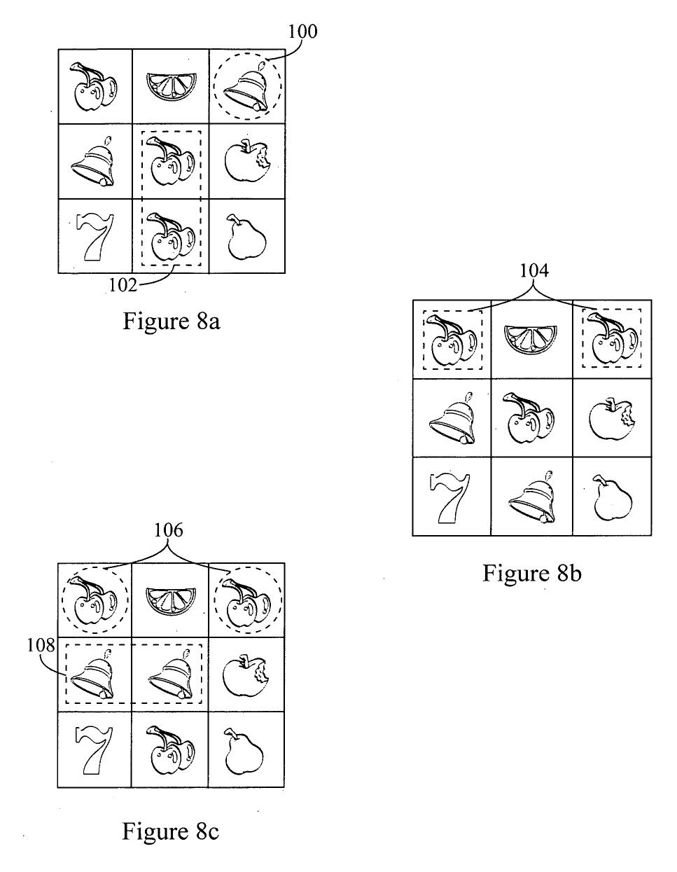

FIGS. 8a, 8b and 8c illustrate a game wherein the number of indicia to shuffle is identified by the outcome, the number of shuffling is predetermined (two), and the game rules and the shuffling game rules are different. The first outcome is evaluated according to line game rules while the subsequent outcomes are evaluated by counting the number of occurrences of a symbol on a horizontal line, regardless of their position. FIG. 8a illustrates a screen shot of the first outcome. Since there are three occurrences of a symbol (“Cherry” symbol), the player may select three indicia to shuffle. He selects the “Bell” symbol 100 on the first line and both “Cherry” symbols 102 in the second column to shuffle to enhance his chances of getting a winning outcome in the subsequent outcomes. FIG. 8b illustrates a screen shot of the second outcome wherein two “Cherry” symbols 104 appear on the first line, which is, according to the shuffling game rules, a winning outcome. The outcome produced by the second shuffling is illustrated on FIG. 8c. In this subsequent outcome, two winning lines are present since there are two “Cherry” symbols 106 on the first line and two “Bell” symbols 108 on the second line.

While illustrated in the block diagrams as groups of discrete components communicating with each other via distinct data signal connections, it will be understood by those skilled in the art that the preferred embodiments are provided by a combination of hardware and software components, with some components being implemented by a given function or operation of a hardware or software system, and many of the data paths illustrated being implemented by data communication within a computer application or operating system. The structure illustrated is thus provided for efficiency of teaching the present preferred embodiment.

It should be noted that the present invention can be carried out as a method, can be embodied in a system, a computer readable medium, processor-readable memory or an electrical or electro-magnetic signal.

The embodiments of the invention described above are intended to be exemplary only. The scope of the invention is therefore intended to be limited solely by the scope of the appended claims.

1. A method of playing a game of chance comprising:
providing a plurality of game indicia to form a first outcome;
evaluating said first outcome according to game rules;
shuffling at least part of said plurality of game indicia to form a second outcome; and
evaluating said second outcome according to shuffling game rules.

2. The method of claim 1, further comprising receiving a player shuffling activation.

3. The method of claim 1, further comprising receiving a wager from a player.

4. The method of claim 3, further comprising receiving another wager from a player.

5. The method of claim 1, wherein the step of shuffling comprises receiving a player selection of game indicia.

6. The method of claim 1, wherein at least three game indicia are shuffled.

7. The method of claim 1, further comprising awarding a shuffling permission upon occurrence of a shuffling triggering event in said first outcome.

8. The method of claim 5, wherein the step of awarding a shuffling permission comprises gathering said shuffling permission for use during a subsequent play.

9. The method of claim 1, further comprising reshuffling said at least part of said plurality of game indicia to form a subsequent outcome and evaluating said subsequent outcome according to shuffling game rules.

10. The method of claim 7, wherein the steps of reshuffling and evaluating said subsequent outcome are repeated until the occurrence of at least one of: a) a predetermined number of reshuffling are used up; b) a randomly determined number of reshuffling are used up; c) gathered shuffling permissions are all used up; and d) a predetermined condition is met.

11. The method of claim 7, further comprising receiving a subsequent wager from a player.

12. The method of claim 7, wherein said game rules and said shuffling game rules are identical.

13. The method of claim 1, wherein the at least part of game indicia to shuffle is determined based on at least one of: a) wagering data; b) outcome data; c) said game rules; and d) said shuffling game rules.

14. The method of claim 1, wherein said game rules and said shuffling game rules are identical.

15. A game apparatus comprising:
display means to display game indicia forming first and second outcomes;
evaluating means to evaluate first outcome according to game rules and second outcomes according to shuffling game rules; and
shuffling means to shuffle indicia from said first outcome to form said second outcome.

16. The apparatus of claim 15, further comprising input means to receive player inputs.

17. The apparatus of claim 15, further comprising awarding means to award prizes.

18. A computer program embodied on a computer readable medium or in processor-readable memory having codes adapted to:
provide a plurality of game indicia to form a first outcome;
evaluate said first outcome according to game rules;
shuffle at least part of said plurality of game indicia to form a second outcome; and
evaluate said second outcome according to shuffling game rules.

19. A computer program carried on an electrical or electro-magnetic carrier signal having codes adapted to:
provide a plurality of game indicia to form a first outcome;
evaluate said first outcome according to game rules;
shuffle at least part of said plurality of game indicia to form a second outcome; and
evaluate said second outcome according to shuffling game rules.
